(19) United States
(12) Patent Application Publication
(10) Pub. No.: US 2025/0066035 A1
(43) Pub. Date: Feb. 27, 2025

(54) ADJUSTABLE EQUIPMENT MOUNTING SYSTEM

(71) Applicant: Tusas- Turk Havacilik Ve Uzay Sanayii Anonim Sirketi, Kahramankazan, Ankara (TR)

(72) Inventor: Taylan SUMAN, Kahramankazan, Ankara (TR)

(73) Assignee: Tusas- Turk Havacilik Ve Uzay Sanayii Anonim Sirketi, Kahramankazan, Ankara (TR)

(21) Appl. No.: 18/724,698

(22) PCT Filed: Nov. 9, 2022
(86) PCT No.: PCT/TR2022/051268

§ 371 Date: Jun. 27, 2024

(30) Foreign Application Priority Data
Dec. 28, 2021 (TR) 2021/021420

(51) Int. Cl. B64D 43/02; B64C 7/00

(52) U.S. Cl. CPC B64D 43/02; B64C 7/00

(57) ABSTRACT

The present invention relates to a body (G); an intermediate piece (2) located on the body (G) so as to extend outward from the body (G); a tube (3) in a cylindrical form removably attached to the intermediate piece (2), extending in at least two directions and/or having a bend; at least equipment (E) removably attached to the tube (3); a first fastener (4) which enables the tube (3) to be fixed to the intermediate piece (2).

The present invention relates to an adjustable equipment mounting system which provides angular adjustment for equipment requiring precise angular positioning.

“Helicopter Air Data Systems” (HADS) equipment is connected to the helicopter body and positioned at a location predetermined by the user. “Helicopter Air Data Systems” equipment is an equipment that measures speed, direction and temperature data of air. In order for said equipment to operate effectively, the equipment must be positioned on the helicopter with relatively narrow angle tolerances in the three axes that are pitch, roll, yaw angles. The ability to adjust pitch, roll and yaw angles of the equipment while mounting on the helicopter enables helicopter manufacturers to perform the assembly process of the equipment on the helicopter body in a cheap, easy and quick manner.

The United States patent application U.S. Pat. No. 10,048,103B2, which is included in the known-state of the art, discloses an adjustable position pitot tube mount. The pitot tube mount is used for operating or flight testing an air vehicle. Thanks to the telescopic feature, the pitot tube can be adjusted in all directions that can be obtained with a spherical joint, and the spherical joint provides rotation in all directions. The telescopic feature provides the sensor to move in or out relative to the air vehicle. By combining the telescopic feature with the spherical feature, any orientation of the pitot probe can be achieved.

In the state of the art, “Helicopter Air Data Systems” equipment in helicopters is connected to the body by means of a rigid tube extending outward from the body. Precision of positioning the equipment on the helicopter is determined by manufacturing tolerances of the tube itself and the precision of the assembly process.

Thanks to an adjustable equipment mounting system according to the present invention, the “Helicopter Air Data Systems” equipment can be mounted to the helicopter with adjustable angular positions.

Another object of the present invention is to provide an adjustable equipment mounting system that can be produced in a cheap, easy and quick manner.

Another object of the present invention is to reduce the possibility of scrapping if the required manufacturing precisions of the tube that enable mounting of the “Helicopter Air Data Systems” equipment to the helicopter are not met.

The adjustable equipment mounting system realized to achieve the object of the invention, which is defined in the first claim and other claims dependent thereon, comprises a body; an intermediate piece provided on the body so as to extend outward from the body. The equipment is removably attached to the intermediate piece. The tube is a substantially L-shaped convoluted tube extending along at least two axes. The direction change corner of the L-shaped tube may have a corner transition with a sharp corner or a radius bend. The intermediate piece is a cylindrical piece. First fastener provides a removable fixation of the tube to the intermediate piece.

The adjustable equipment mounting system according to the invention comprises a protrusion in which the intermediate piece and the tube are engaged. The protrusion acts as a surface that enables precise insertion of the tube into the intermediate piece, wherein the tube is rotated around an axis along which the tube extends, so that the it is attached to the intermediate piece. The protrusion is geometrically form-fitting with the tube. The protrusion is concentric with the tube and has the form of a cylindrical mouth. The first adjustment area is provided in an area of the tube that engages with the protrusion. The first adjustment area is sized so that the first fastener can pass therethrough, and has a geometry that enables the first fastener to be removably attached. The first adjustment area has a cylindrical form and comprises a height portion extending outward from the base of the cylinder, which is a circular cross-sectional area. The first adjustment area is located on an outer surface of the height portion and is a channel all around. The first adjustment area enables fixation of the tube by attaching the first fastener in an angular position, wherein the tube is rotated by the user around the direction it extends longitudinally, so as to be brought the angular position. In the first adjustment area, the user rotates the tube around the direction it extends longitudinally, so that preliminary angular position of the equipment is changed. The first fastener can be attached and fixed at a peripheral position desired by the user in the first adjustment area. The circumferential position refers to the radial direction of a circle.

In an embodiment of the invention, the adjustable equipment mounting system comprises the body forming an outer aerodynamic surface of the helicopter. A centerline is provided, which is the roll axis of the air vehicle or is parallel to the roll axis of the air vehicle, and extends from the nose of the body to the tail cone or rear tail thereof. The body performs a rolling motion by rotating around the centerline. The plane of symmetry passes through the centerline and divides the air vehicle into two substantially symmetrical parts, virtually or apparently. The plane of symmetry is the plane of the zero buttline, one of the definitions used to describe air vehicle positions. The first adjustment axis is the axis of the tube and protrusion, which are coaxial. The symmetric plane angle is an angle value other than zero, which is determined by the user, and is defined as the angle between the plane of symmetry and the first adjustment axis. The protrusion extends outward from the intermediate piece. The direction along which the protrusion extends longitudinally and the first adjustment axis extend along the longitudinal position angle, so that the tube to which the protrusion is attached is also positioned to extend along the symmetrical plane angle.

In an embodiment of the invention, the adjustable equipment mounting system comprises the body forming an outer aerodynamic surface of the helicopter. The body plane lies perpendicular to the centerline, which is the roll axis of the air vehicle, and it is the fuselage station used to enumerate different length coordinates of the body along the air vehicle's longitudinal axis. The longitudinal position angle is predetermined by the user, defined as the angle between the plane of the body and the first adjustment axis, and has an angle value other than zero. The direction, along which the protrusion extends outward from the intermediate piece, extends along the longitudinal position angle, so that the tube to which the protrusion is attached is also positioned to extend along the longitudinal position angle.

In an embodiment of the invention, the adjustable equipment mounting system comprises at least one cylindrical adapter located between the tube and the equipment. There is a second adjustment axis along which the tube, adapter and equipment extend in the same direction. The equipment fastener provides the equipment to be removably attached to the adapter and, when attached, to rotate the adapter and equipment by the amount of iso-angular position. The second fastener provides the adapter to be attached to the tube removably. The second adjustment area is provided on the adapter, where the tube and the adapter are engaged. The adapter is cylindrical. The second adjustment area is provided as an opening in the form of a channel, and is located to surround the outer surface of the adapter, which is the cylindrical height portion extending outward from the base with a circular cross-sectional area. The second adjustment area enables the adapter to be attached to the tube removably, and provides the equipment to be fixed by the user attaching the second fastener in the angular position to which adapter and equipment are brought by rotating around the direction they extend. Therefore, the second adjustment area provides precise pitch change for the equipment. The opening in the second adjustment area is such that the second fastener can pass through. The second fastener can be fixed at a peripheral position desired by the user in the second adjustment area.

In an embodiment of the invention, the adjustable equipment mounting system comprises a bushing. The axis, along which the bushing extends longitudinally, is on the second adjustment axis. One of the ends to which the bushing is connected is engaged with the tube, has a stepped structure and has circular cross-sectional areas with different diameters. The other connected-end of the bushing is engaged with the adapter. The bushing acts as a ball bearing-like outer surface on which the adapter can rotate. The bushing is rotated by the user around the second adjustment axis of the adapter and the equipment together, resulting in the final pitch change of the equipment.

In an embodiment of the invention, the adjustable equipment mounting system comprises the second adjustment area. The second adjustment area is provided in thane area where adapter and bushing are engaged. The adapter is substantially cylindrical. The second adjustment area is provided on an outer surface of the height portion of the cylindrical adapter that extends outward from the circular base, and substantially surrounds the height portion. The second adjustment area is provided as an opening in the form of a channel. Height portion refers to the outer surface of the cylinder or the length portion of the cylinder extending outward from the base area of the cylinder.

In an embodiment of the invention, the adjustable equipment mounting system comprises an abutment surface. The abutment surface is provided on the intermediate piece, has a circular cross-sectional area and has a flanged structure. The flanged structure means that the abutment surface has a stepped structure or has circular cross-sectional areas with different diameters. The abutment surface has a cross-sectional area greater than the outer diameter of the tube. The abutment surface acts as a stopper for the tube when mounting the tube to the intermediate piece along the axis of the tube which is coaxial with the axis along which the protrusion extends longitudinally.

In an embodiment of the invention, the adjustable equipment mounting system comprises the intermediate piece. Edges of the intermediate piece on the body have a radius form predetermined by the user. Therefore, the intermediate piece acts as a fairing and enables the intermediate piece to be exposed to a low drag force.

In an embodiment of the invention, the adjustable equipment mounting system comprises the protrusion. Mounting of the equipment is performed by the user following the steps of: inserting the tube into the intermediate piece such that the tube abuts or substantially contacts the abutment surface, rotating the tube around its own axis that the tube extends longitudinally, so that roll, pitch and yaw angle are adjusted for the equipment, performing the adjustment of the first adjustment area by attaching the first fastener, after that, rotating the equipment connected to the adapter around the second adjustment axis so as to make precise pitch adjustment of the equipment, and performing adjustment of the second adjustment area by attaching the second fastener, respectively.

In an embodiment of the invention, the adjustable equipment mounting system comprises the equipment which is a “Helicopter Air Data Systems” that measures speed, direction and temperature data of the air.

In an embodiment of the invention, the adjustable equipment mounting system comprises the tube having a base with a circular cross-sectional area for easy manufacturability. The tube may alternatively have a base with a cross-sectional area in the form of an airfoil so that the body and/or tube are subject to less drag. For easy manufacturability, the cross-sectional areas of the tube are the same as the section of the base.

In an embodiment of the invention, the adjustable equipment mounting system comprises a support element. Due to equipment operating conditions, the equipment must be located at a distance predetermined by the user from the body. With the effect of the weight of the equipment and the distance of the equipment to the body, the equipment causes the tube to be bent or deformed. The support element is located between the body and the tube to prevent tube deformation and acts as a supporter that reduces tube deformation. Thus, the support element helps the precise positioning of the equipment in terms of position and angle. The mechanical clamp contributes to ensuring that the support element surrounds the tube effectively, while also contacting the tube substantially around the circumference of the tube. The mechanical clamp is a clamp type mechanical connection. The support element extends outward from the body, towards the part of the tube that is close to the bend, and there is a distance between the support element and the intermediate piece predetermined by the user.

In an embodiment of the invention, the adjustable equipment mounting system comprises a laser. The laser enables the detection of the roll, pitch and yaw angles around the roll, pitch and yaw axes of the equipment and whether they are within the tolerances predetermined by the user. The laser is mounted removably to the adapter only when performing the adjustment process before the equipment is attached, in order to achieve the ideal angular positions of the first adjustment area and the second adjustment area to which they are brought by the user, and enables the determination of whether the roll, pitch and yaw angles around the roll, pitch and yaw axes of the equipment are within the desired tolerances.

In an embodiment of the invention, the adjustable equipment mounting system comprises the body forming an outer aerodynamic surface of a helicopter, UAV or aircraft.

In an embodiment of the invention, the adjustable equipment mounting system comprises the intermediate piece manufactured by using the NC manufacturing method. In this way, only the intermediate piece is produced precisely, production costs are reduced and production can be carried out more quickly. Thus, the assembly is made easier.

The adjustable equipment mounting system realized to achieve the object of the present invention is illustrated in the attached drawings, in which:

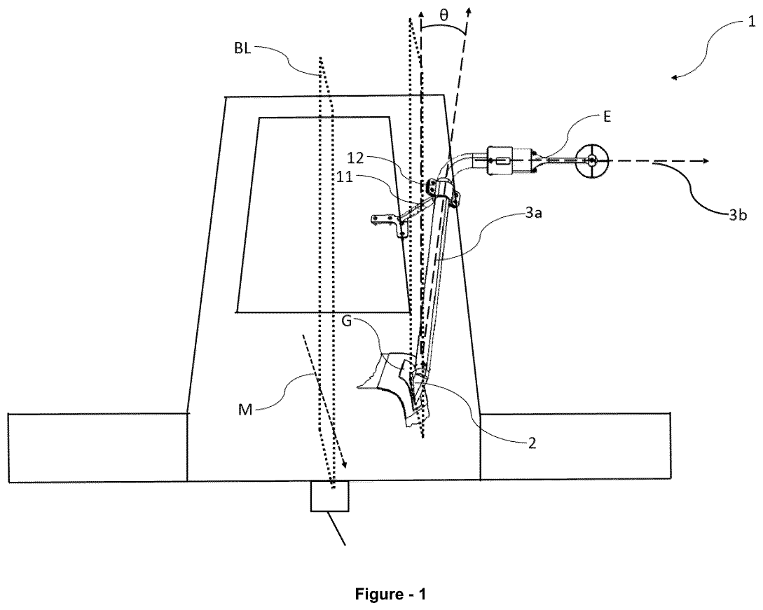

FIG. 1 is a front view of an adjustable equipment mounting system.

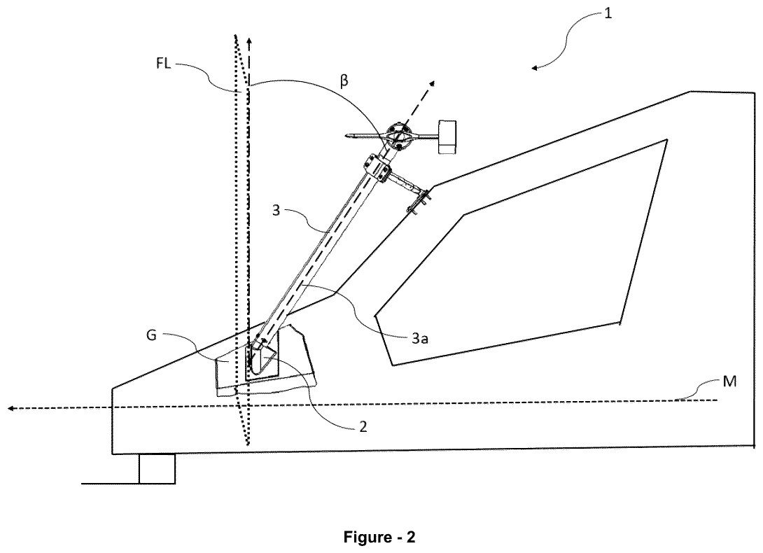

FIG. 2 is a side view of an adjustable equipment mounting system.

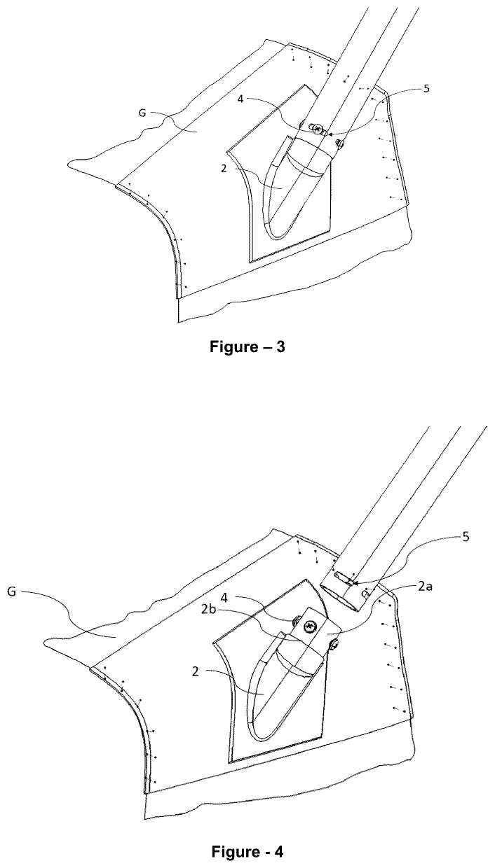

FIG. 3 is a perspective view of the first adjustment area in an assembled state.

FIG. 4 is an exploded view of the first adjustment area in an assembled state.

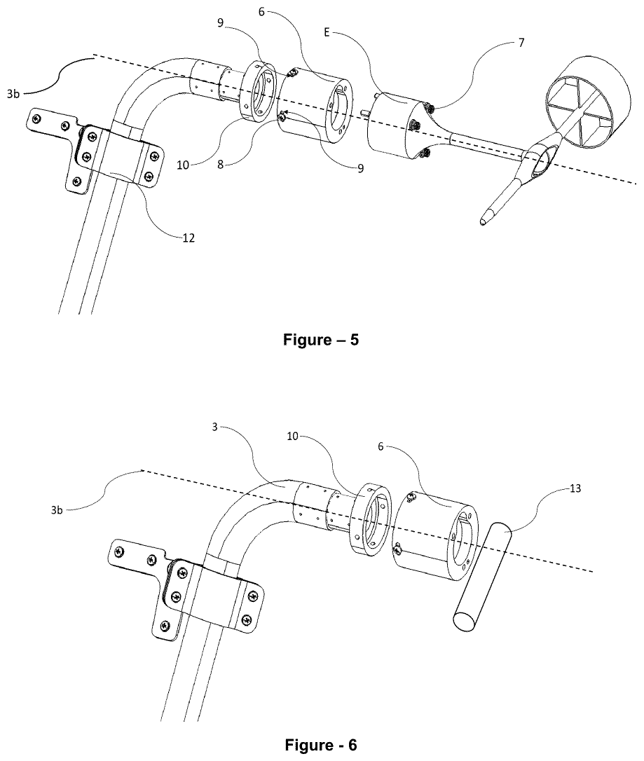

FIG. 5 is an exploded view of the second adjustment area in an assembled state.

FIG. 6 is a perspective view of the adapter, tube, bushing and laser.

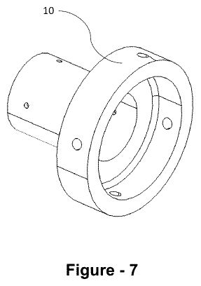

FIG. 7 is a perspective view of the bushing.

All the parts illustrated in figures are individually assigned a reference numeral and the corresponding terms of these numbers are listed below:
1. Adjustable equipment mounting system
2. Intermediate piece
   2a. Protrusion
   2b. Abutment surface
3. Tube
   3a. First adjustment axis
   3b. Second adjustment axis
4. First fastener
5. First adjustment area
6. Adapter
7. Equipment fastener
8. Second fastener
9. Second adjustment area
10. Bushing
11. Support element
12. Mechanical clamp
13. Laser
(G) Body
(E) Equipment
(M) Centerline
(θ) Symmetrical plane angle
(β) Longitudinal position angle
(BL) Plane of symmetry
(FL) Body plane

The adjustable equipment mounting system (1) comprises a body (G); an intermediate piece (2) located on the body (G) so as to extend outward from the body (G); a tube (3) in a cylindrical form removably attached to the intermediate piece (2), extending in at least two directions and/or having a bend; at least equipment (E) removably attached to the tube (3); a first fastener (4) which enables the tube (3) to be fixed to the intermediate piece (2) (FIG. 4).

The adjustable equipment mounting system (1) according to the invention comprises a cylindrical protrusion (2a) form-fitting with the tube (3), which is inserted into the tube (3) and provides the tube (3) to be attached to the intermediate piece (2) and rotated around its own axis; a first adjustment area (5) which is located in a part of the tube (3) that is engaged with the protrusion (2a), provides the first fastener (4) to be attached, and is provided as an opening provided on the outer surface of the cylindrical tube (3), wherein the first adjustment area (5) provides the tube (3) to be fixed by means of the first fastener (4) in a position to which the tube (3) is brought by rotating around its own axis, thereby provideing the angular position change of the equipment (E) to be performed by rotating the tube (3) around its own axis (FIG. 3, FIG. 4).

The adjustable equipment mounting system (1) enables that the equipment (E) is mounted on the helicopter body (G) to be positioned within angular position tolerances predetermined by the user. “Helicopter Air Data Systems” equipment (E) enables measurement of speed, direction and temperature data of air. The manufacturing tolerances and assembly tolerances of the tube (3) itself determine the angular positioning precision of the equipment (E). The intermediate piece (2) extends outwards and/or inwards over the body (G) and is produced within precise tolerances. The first fastener (4) enables the tube (3) to be attached removably to the intermediate piece (2) (FIG. 1, FIG. 4).

Since the tube (3) is produced quickly and cheaply, only the intermediate piece (2) is produced with relatively high production precision, and the angular position adjustment is provided during assembly by the first adjustment area (5), a fast, inexpensive and effective adjustable equipment mounting system is realized. Due to the fact that the tube (3) is rotated around its own axis to provide tolerances required for the angular precision of the equipment (E) and the first fastener (4) is attached to the first adjustment area (5) in an angular position providing the equipment (E) tolerance, an ammunition support mechanism (1) is provided, which enables the tube (3) and the equipment (E) to be fixed in an angular position that ensures the equipment (E) tolerance. Angular position refers to the roll angle, yaw angle and rotation angle around the three axes of roll, yaw and rotation. The protrusion (2a) is manufactured with precise manufacturing tolerances and partially engages with the tube (3) (FIG. 3, FIG. 4).

In an embodiment of the invention, the adjustable equipment mounting system (1) comprises a centerline (M) extending longitudinally from the nose to the tail cone of the body (G) that is the air vehicle; a plane of symmetry (BL) passing through the centerline (M) and dividing the body (G) into two substantially symmetrical parts; a first adjustment axis (3a) along which the tube (3) and the protrusion (2a) extend longitudinally; a symmetrical plane angle (θ) predetermined by the user, which is an angle between the plane of symmetry (BL) and the first adjustment axis (3a); the protrusion (2a) extending substantially along the symmetrical plane angle (θ) outward from the intermediate piece (2), thus enabling the tube (3) to which it is attached to be positioned to extend substantially along the symmetrical plane angle (e). Thanks to the protrusion (2a) providing the tube (3) to extend along the symmetrical plane angle (θ) predetermined by the user, if the user rotates the L-shaped tube (3) substantially from the first adjustment area (5) around its own axis/first adjustment axis (3a) by x degrees, yaw angle of the equipment (E) also rotates x degrees and angular position change is provided for pitch and roll axes of the equipment (E). Thus, the angular position of the equipment (E) is changed in the 3 angular positions of yaw, pitch and roll angles, only by providing the user to change the angle through the first adjustment area (5). “X degrees” refers to any angle value determined by the user (FIG. 1).

In an embodiment of the invention, the adjustable equipment mounting system (1) comprises a body plane (FL) perpendicular to the centerline (M) and passing through the centerline (M) of the body (G) which is the air vehicle; a longitudinal position angle (3) predetermined by the user, which is an angle between the body plane (FL) and the first adjustment axis (3a); the protrusion (2a) extending substantially along the longitudinal position angle (β) outward from the intermediate piece (2), thus enabling the tube (3) to which it is attached to be positioned to extend substantially along the longitudinal position angle (β). Thanks to the protrusion (2a) providing the tube (3) to extend along the longitudinal position angle (β) predetermined by the user, if the user rotates the L-shaped tube (3) substantially from the first adjustment area (5) around its own axis by x degrees, yaw angle of the equipment (E) also rotates x degrees and angular position change is provided for pitch and roll axes of the equipment (E). Thus, the angular position of the equipment (E) is changed in the 3 angular positions of yaw, pitch and roll angles, only by providing the user to change the angle through the first adjustment area (5). Moreover, since the protrusion (2a) provides the tube (3) to extend along both the symmetrical plane angle (θ) and the longitudinal position angle (β) predetermined by the user, if angle adjustment is made for the equipment (E) by x degrees through the first adjustment area (5), yaw angle of the equipment (E) changes by x degrees, as well as changing pitch and roll angles with a combined effect of the symmetrical plane angle (θ) and the longitudinal position angle (3) (FIG. 1, FIG. 2).

In an embodiment of the invention, the adjustable equipment mounting system (1) comprises at least one adapter (6) in a cylindrical form, which is located between the tube (3) and the equipment (E); a second adjustment axis (3b) along which tube (3), adapter (6) and equipment (E) extend longitudinally substantially in a coaxial manner; an equipment fastener (7) that enables the equipment (E) to be attached removably to the adapter (6) so as to move together; a second fastener (8) which provides the adapter (6) to be removably attached to the tube (3); a second adjustment area (9) on the adapter (6), which is provided as a substantially all-round opening in the interlocking part of the tube (3) and the adapter (6), and provides the adapter (6) to be removably attached to the tube (3), wherein the second adjustment area (9) provides equipment (E) and adapter (6) to be fixed in a position, to which they are brought by rotating around the second adjustment axis (3b), by means of the second fastener (8), thus providing the final pitch angle of the equipment (E) to be adjusted. If the user provides an angle change by x degrees through the second adjustment area (9), only the pitch angle of the equipment (E) changes by x degrees. The second adjustment area (9) provides only the pitch angle change of the equipment (E). After the preliminary angle adjustment of the equipment (E) is made through the first adjustment area (4), the precise and final pitch angle adjustment is performed through the second adjustment area (9) (FIG. 5, FIG. 6).

In an embodiment of the invention, the adjustable equipment mounting system (1) comprises a bushing (10) with cross-sectional areas of different diameters, which extends outward from the tube (3) along the second adjustment axis (3b) and acts as a part for the adapter (6) to rotate thereon, wherein one end of the bushing (10) is at least partially engaged with the tube (3), and the other end thereof is at least partially engaged with the adapter (6), wherein the bushing (10) provides precise pitch angle adjustment of the equipment (E) by rotating the adapter (6) and the equipment (E) around the second adjustment axis (3b). Thus, the adapter (6) and the equipment (E) can be easily rotated around the second adjustment axis (3b) on the bushing, with low friction (FIG. 6, FIG. 7).

In an embodiment of the invention, the adjustable equipment mounting system (1) comprises the second adjustment area (9) which is provided as an opening on the outer surface of the adapter (6) in a cylindrical form, in the interlocking part of the adapter (6) and the bushing (10), and which substantially surrounds the outer surface of the adapter (6). Since the second adjustment area (9) is provided as a substantially all-round opening, the user can fix it in the second adjustment area (9) at the desired angle by means of the second fastener (8) (FIG. 5, FIG. 6).

In an embodiment of the invention, the adjustable equipment mounting system (1) comprises an abutment surface (2b) in a circular form with a diameter substantially larger than the outer diameter of the tube (3), which is located on the intermediate piece (2) and has cross-sectional areas of different diameters, wherein the abutment surface (2b) enables restriction of the axial movement of the tube (3) along the first adjustment axis (3a). Thus, while the user is assembling the equipment (E) to the body (G), the user can adjust the angle more comfortably through the first adjustment area (5) after the tube (3) is abutted on the abutment surface (2b) (FIG. 4).

In an embodiment of the invention, the adjustable equipment mounting system (1) comprises the intermediate piece (2), which has radiused edges on the body (G) and thus provides effective aerodynamic performance by acting as a fairing. Since the intermediate piece (2) has smooth and even edge transitions on its edges, it provides less drag effect aerodynamically (FIG. 3, FIG. 4).

In an embodiment of the invention, the adjustable equipment mounting system (1) comprises the protrusion (2a) which provides for:
translating the tube (3) along the first adjustment axis (3a) such that it is positioned to contact the abutment surface (2b), and attaching the tube (3) to the intermediate piece (2),
rotating the tube (3) around the first adjustment axis (3a) through the first adjustment area (5) to adjust the roll, pitch and yaw angles of the equipment (E),
rotating adapter (6) and equipment (E) around the second adjustment axis (3b) through the second adjustment area (9) to perform final pitch angle adjustment of the equipment (E). After the user performs preliminary angle adjustment through the first adjustment area, precise pitch angle adjustment is performed through the second adjustment area (FIG. 3, FIG. 4, FIG. 5).

In an embodiment of the invention, the adjustable equipment mounting system (1) comprises the equipment (E) which is a “Helicopter Air Data System” that measures speed, direction and temperature information of the air (FIG. 1).

In an embodiment of the invention, the adjustable equipment mounting system (1) comprises the tube (3) which has a circular cross-section and thus can be produced easily or has an airfoil-shaped cross-section, thereby increasing the effective aerodynamic performance of the body (G) (FIG. 1, FIG. 3, FIG. 5).

In an embodiment of the invention, the adjustable equipment mounting system (1) comprises at least one support element (11) extending from the body (G) towards the tube (3) and contributing to the precise positioning of the equipment (E) and to the reduction of the tube (3) deformation due to the weight of the equipment (E); a mechanical clamp (12) removably attached to the tube (3), which is a clamp-type mechanical connection substantially surrounding the tube (3), and is located at a part of the support element (11) contacting the tube (3). Thus, the deformation caused by bending due to the weight of the equipment (E) and the distance of the equipment (E) to the part where the tube (3) is supported, is reduced (FIG. 1).

In an embodiment of the invention, the adjustable equipment mounting system (1) comprises a laser (13) which is temporarily attached to the adapter (6) for the purpose of determining the positions of the first adjustment area (5) and the second adjustment area (9), and enables the positioning of the equipment (E) around the axes of roll, pitch and yaw. The user installs laser (13) on the location of the equipment (E) to ensure that components of the adjustable equipment mounting system (1) are adjusted in desired angular positions before the equipment (E) is installed, and it is determined whether the angular position of the equipment (E) provides the required tolerances by providing the laser (13) to be projected onto the point cloud marked on an object representing the desired tolerance range. After it is understood that the required tolerances are met, the laser (13) is removed, the equipment (E) is replaced and the adjustment process is completed (FIG. 6).

In an embodiment of the invention, the adjustable equipment mounting system (1) comprises a body (G) which is a helicopter, UAV or aircraft (FIG. 1).

In an embodiment of the invention, the adjustable equipment mounting system (1) comprises the intermediate piece (2) produced by NC manufacturing method. Thus, only because the intermediate piece (2) is produced with relatively high production tolerances, an effective adjustable equipment mounting system design is realized, while reducing the production time and costs and the probability of scrapping the adjustable equipment mounting system (1) (FIG. 3, FIG. 4).

1. An adjustable equipment mounting system comprising a body (G); an intermediate piece located on the body (G) so as to extend outward from the body (G); a tube in a cylindrical form removably attached to the intermediate piece, extending in at least two directions; at least equipment (E) removably attached to the tube; a first fastener which provides the tube to be fixed to the intermediate piece, wherein a cylindrical protrusion form-fitting with the tube, which is inserted into the tube and provides the tube to be attached to the intermediate piece and rotated around its own axis; a first adjustment area which is located in a part of the tube that is engaged with the protrusion, provides the first fastener to be attached, and is provided as an opening provided on the outer surface of the cylindrical tube, wherein the first adjustment area provides the tube to be fixed by means of the first fastener in a position to which the tube is brought by rotating around its own axis, thereby providing the angular position change of the equipment (E) to be performed by rotating the tube around its own axis.

2. An adjustable equipment mounting system according to claim 1, wherein a centerline (M) extending longitudinally from the nose to the tail cone of the body (G) that is the air vehicle; a plane of symmetry (BL) passing through the centerline (M) and dividing the body (G) into two substantially symmetrical parts; a first adjustment axis along which the tube and the protrusion extend longitudinally; a symmetrical plane angle (θ) predetermined by the user, which is an angle between the plane of symmetry (BL) and the first adjustment axis; the protrusion extending substantially along the symmetrical plane angle (θ) outward from the intermediate piece, thus enabling the tube to which it is attached to be positioned to extend substantially along the symmetrical plane angle (θ).

3. An adjustable equipment mounting system according to claim 2, wherein a body plane (FL) perpendicular to the centerline (M) and passing through the centerline (M) of the body (G) which is the air vehicle; a longitudinal position angle (β) predetermined by the user, which is an angle between the body plane (FL) and the first adjustment axis; the protrusion extending substantially along the longitudinal position angle (β) outward from the intermediate piece, thus enabling the tube to which it is attached to be positioned to extend substantially along the longitudinal position angle (β).

4. An adjustable equipment mounting system according claim 1, wherein at least one adapter in a cylindrical form, which is located between the tube and the equipment (E); a second adjustment axis along which tube, adapter and equipment (E) extend longitudinally substantially in a coaxial manner; an equipment fastener that enables the equipment (E) to be attached removably to the adapter so as to move together; a second fastener which provides the adapter to be removably attached to the tube; a second adjustment area on the adapter, which is provided as a substantially all-round opening in the interlocking part of the tube; and the adapter, and provides the adapter to be removably attached to the tube, wherein the second adjustment area provides equipment (E) and adapter to be fixed in a position, to which they are brought by rotating around the second adjustment axis, by means of the second fastener, thus providing the final pitch angle of the equipment (E) to be adjusted.

5. An adjustable equipment mounting system according to claim 4, wherein a bushing with cross-sectional areas of different diameters, which extends outward from the tube along the second adjustment axis and acts as a part for the adapter to rotate thereon, wherein one end of the bushing is at least partially engaged with the tube, and the other end thereof is at least partially engaged with the adapter, wherein the bushing provides precise pitch angle adjustment of the equipment (E) by rotating the adapter and the equipment (E) around the second adjustment axis.

6. An adjustable equipment mounting system according to claim 5, wherein the second adjustment area which is provided as an opening on the outer surface of the adapter a cylindrical form, in the interlocking part of the adapter and the bushing, and which substantially surrounds the outer surface of the adapter.

7. An adjustable equipment mounting system according to claim 2, wherein an abutment surface in a circular form with a diameter substantially larger than the outer diameter of the tube, which is located on the intermediate piece and has cross-sectional areas of different diameters, wherein the abutment surface enables restriction of the axial movement of the tube along the first adjustment axis.

8. An adjustable equipment mounting system according to claim 1, wherein the intermediate piece, which has radiused edges on the body (G) and thus provides effective aerodynamic performance by acting as a fairing.

9. An adjustable equipment mounting system according to claim 4, wherein the protrusion which provides for:
translating the tube along the first adjustment axis such that it is positioned to contact the abutment surface, and attaching the tube to the intermediate piece,
rotating the tube around the first adjustment axis through the first adjustment area to adjust the roll, pitch and yaw angles of the equipment (E),
rotating adapter and equipment (E) around the second adjustment axis through the second adjustment area to perform final pitch angle adjustment of the equipment (E).

10. An adjustable equipment mounting system according to claim 1, wherein the equipment (E) which is a “Helicopter Air Data System” that measures speed, direction and temperature information of the air.

11. An adjustable equipment mounting system according to claim 1, wherein the tube which has a circular cross-section and thus can be produced easily or has an airfoil-shaped cross-section, thereby increasing the effective aerodynamic performance of the body (G).

12. An adjustable equipment mounting system according to claim 1, wherein at least one support element extending from the body (G) towards the tube and contributing to the precise positioning of the equipment (E) and to the reduction of the tube deformation due to the weight of the equipment (E); a mechanical clamp removably attached to the tube, which is a clamp-type mechanical connection substantially surrounding the tube, and is located at a part of the support element contacting the tube.

13. An adjustable equipment mounting system according to claim 4, wherein a laser which is temporarily attached to the adapter for the purpose of determining the positions of the first adjustment area and the second adjustment area, and enables the positioning of the equipment (E) around the axes of roll, pitch and yaw.

14. An adjustable equipment mounting system according to claim 1, wherein the body (G) which is a helicopter, UAV or aircraft.

15. An adjustable equipment mounting system according to claim 1, wherein the intermediate piece produced by NC manufacturing method.
